(19) United States
(12) Patent Application Publication
(10) Pub. No.: US 2015/0057578 A1
(43) Pub. Date: Feb. 26, 2015

(54) SUCTION OPENING FOR VACUUM ABSORPTION TYPE MASSAGE MACHINE

(71) Applicant: Byung Don Min, Namyangju-si (KR)

(72) Inventor: Byung Don Min, Namyangju-si (KR)

(21) Appl. No.: 14/382,111

(22) PCT Filed: Feb. 27, 2013
(86) PCT No.: PCT/KR2013/001606

§ 371 Date: Aug. 29, 2014

(30) Foreign Application Priority Data
Feb. 29, 2012 (KR) 10-2012-0021213

(51) Int. Cl. A61H 7/00

(52) U.S. Cl. CPC A61H 7/00
USPC 601/6

(57) ABSTRACT

The present invention relates to a suction opening and a cup for cupping for a vacuum absorption type massage machine, and more specifically, to a suction opening and a cup for cupping for a vacuum absorption type massage machine capable of simultaneously reducing pain due to the expansion of skin and rapidly removing a dark-red mark on the skin after massaging by forming partitions at the suction opening and the cup for cupping, respectively, to remove the concentration of stress generated at the front edge of a suction opening for coming in contact with the skin and the lower edge of a cup for cupping.

### TECHNICAL FIELD

The present invention relates to a suction opening for a vacuum absorption type massage machine, and more particularly, to a suction opening and a cupping cup for a vacuum absorption type massage machine, which are capable of simultaneously reducing pain due to expansion of skin and rapidly removing a dark-red mark on the skin after massaging by providing partitions at the suction opening to prevent stress from being concentrated into a front circumferential portion of the suction opening that contacts the skin.

### BACKGROUND ART

In general, massage machines are used for promoting the circulation of the blood to realize muscle relaxation, fatigue recovery, and massage effects. Massage machines may give a stimulus on a skin or muscle by mainly using cam rolling, vibration, air injection, and the like.

In recent years, a new type of vacuum absorption type massage machine that expands a skin to extend a blood vessel and allows blood to be deeply absorbed into the skin from a capillary vessel by using a strong suction force of a suction pump has been developed.

As illustrated in FIG. 10, the conventional vacuum absorption type massage machine includes a body 10 in which a suction pump is built, a connection tube 20 connected to the body 10 and having the other end connected to a lower end of a handle 30, and a suction opening 100 fixed to an upper end of the handle 30 at a right angle.

In the vacuum absorption type massage machine, when the suction pump of the body 10 operates in a state where a front portion of the suction opening is placed on a skin, air may be suctioned through the suction opening to draw the skin and thus expand a blood vessel, thereby realizing massage effects.

Similarly, in a cupping therapy, a cupping cup is placed on a skin to be treated, and then air within a container of the cupping cup is expelled to apply a negative pressure, thereby expanding a blood vessel within a skin to remove extravasated blood. As a result, wastes and toxin within the blood may be removed.

The conventional cupping cup 5 includes a container 500 having an upside-down container shape and a protrusion 600 in which a valve 620 is inserted into an upper end of the container 500.

The cupping cup may be placed on a skin to be treated, and then, air within the container 500 may be expelled through the protrusion 600 of the cupping cup by using a compressor 1 to apply a negative pressure.

A technology about the conventional vacuum absorption type massage machine is disclosed in Korean Utility Model Registration Gazette No. 044887, and a technology about the cupping cup is disclosed in Korean Utility Model Registration Gazette No. 0431001.

### DISCLOSURE OF THE INVENTION

### Technical Problem

However, the suction opening or cupping cup for the conventional vacuum absorption type massage machine has problems as follows:

(1) When air is suctioned through the suction opening, a skin may be convexly pulled up toward an inner central portion of the suction opening. Here, the skin contacting a circumferential portion of the suction opening may be seriously pressed to cause pain.

(2) A mark remaining after the messaging may last for a long time to cause an aesthetic problem.

(3) For sufficiently expanding the blood vessel, a large amount of air has to be suctioned. Thus, a person that gets massage or cupping therapy may feel severe pain.

### Technical Solution

To solve the above-described problems, the present invention provides a suction opening for a vacuum absorption type massage machine, which is coupled to a handle of the vacuum absorption type massage machine, the suction opening including:

a main body; a coupling part disposed at a rear portion of the main body, the coupling part being coupled to the handle, and a partition disposed within the main body.

Also, in another embodiment, the present invention provides a general cupping cup including a container and a protrusion, characterized in that a partition is disposed within the container.

### Advantageous Effects

According to the suction opening or cupping cup for the vacuum absorption type message machine, following effects may be achieved.

(1) Since a portion pressing the skin is widely distributed by the partition when air is suctioned into the suction opening or the cupping cup by the vacuum pump or compressor, a person that gets the massage may feel relatively less pain.

(2) Since the mark generated on the skin is divided into several portions, and the applied pressure is dispersed, the mark on the skin may be quickly removed.

(3) Since the person that gets the massage feels relatively less pain even though the vacuum or compressor operates to apply a higher pressure so as to suction air into the suction opening or cupping cup, the massage effects may increase double.

### BRIEF DESCRIPTION OF THE DRAWINGS

FIG. 3 is a side cross-sectional view illustrating a modified example of a partition of a suction opening for a vacuum absorption type massage machine according to a preferred embodiment of the present invention.

FIG. 4 is a side cross-sectional view illustrating another modified example of the partition of the suction opening for the vacuum absorption type massage machine according to a preferred embodiment of the present invention.

FIG. 5 is a side cross-sectional view illustrating further another modified example of the partition of the suction opening for the vacuum absorption type massage machine according to a preferred embodiment of the present invention.

FIG. 6 is a side cross-sectional view for comparing an operation of the suction opening for the vacuum absorption type massage machine according to a preferred embodiment of the present invention to an operation of a suction opening according to a related art.

FIG. 7 is a front view of a state in which a main body of the suction opening for the vacuum absorption type massage machine and partitions having various shapes are coupled to each other according to a preferred embodiment of the present invention.

FIG. 8 is an exploded perspective view of a suction opening for a vacuum absorption type massage machine according to another embodiment of the present invention.

FIG. 9 is a perspective view illustrating various square shapes of a main body of the suction opening for the vacuum absorption type massage machine according to a preferred embodiment of the present invention.

FIG. 10 is a perspective view of a vacuum absorption type massage machine according to the related art.

FIG. 11 is a side cross-sectional view of a cupping cup according to further another embodiment of the present invention.

FIG. 12 is a perspective view illustrating a modified example of the cupping cup according to further another embodiment of the present invention.

FIG. 13 is a perspective view of a cupping cup according to the related art.

### MODE FOR CARRYING OUT THE INVENTION

According to the present invention, a suction opening 100 is defined to be coupled to a handle 30 of a general vacuum absorption type massage machine.

The suction opening 100 includes a main body 110, and a fixing wing part 112 is disposed on a circumferential portion of the main body 110. A coupling part 120 to be coupled to the handle 30 is disposed at a rear portion of the main body 110, and a partition 130 is disposed within the main body 110.

The main body 110 has a cylindrical or oval cylindrical shape. The partition 130 may be insertable into or separable from the main body 110.

The fixing wing part 112 may protrude to the outside so that the coupling part 120 is easily coupled to or separated from the handle 30.

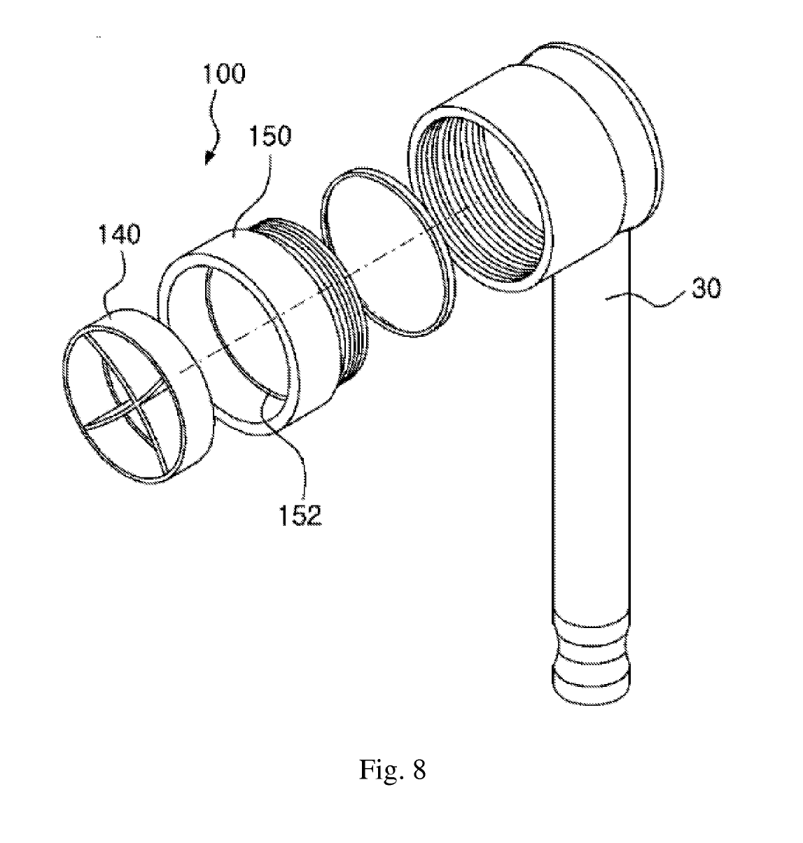

The partition 130 may be disposed within the main body 110. As illustrated in FIG. 7, the partition 130 may have various shapes such as a cross shape, a “Y” shape, a straight shape, a lattice shape, a cross shape having a circular center, and the like.

That is, an inner space of the main body 110 may be partitioned by the partition 130. For example, the inner space may be divided into four parts by the cross-shaped partition 130, divided into three parts by the Y-shaped partition 130, and divided into two parts by the straight-shaped partition 130.

When the main body 110 has a large diameter, the inner space of the main body 110 may be divided into a plurality of reticulated parts.

The partition 130 may have a front portion that is disposed in parallel to a front portion of the main body 110. The front portion of the partition 130 may be gradually concavely retreated toward a central portion thereof.

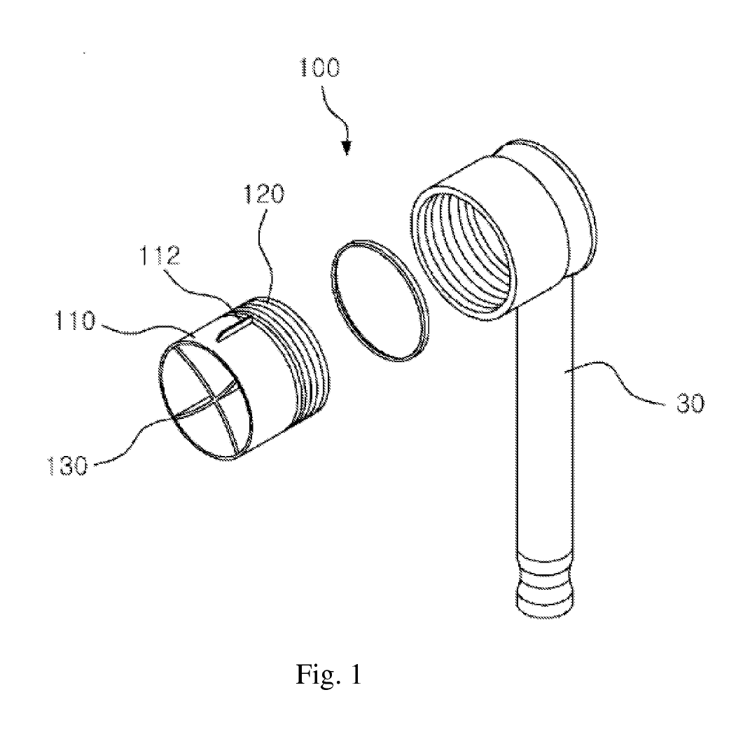

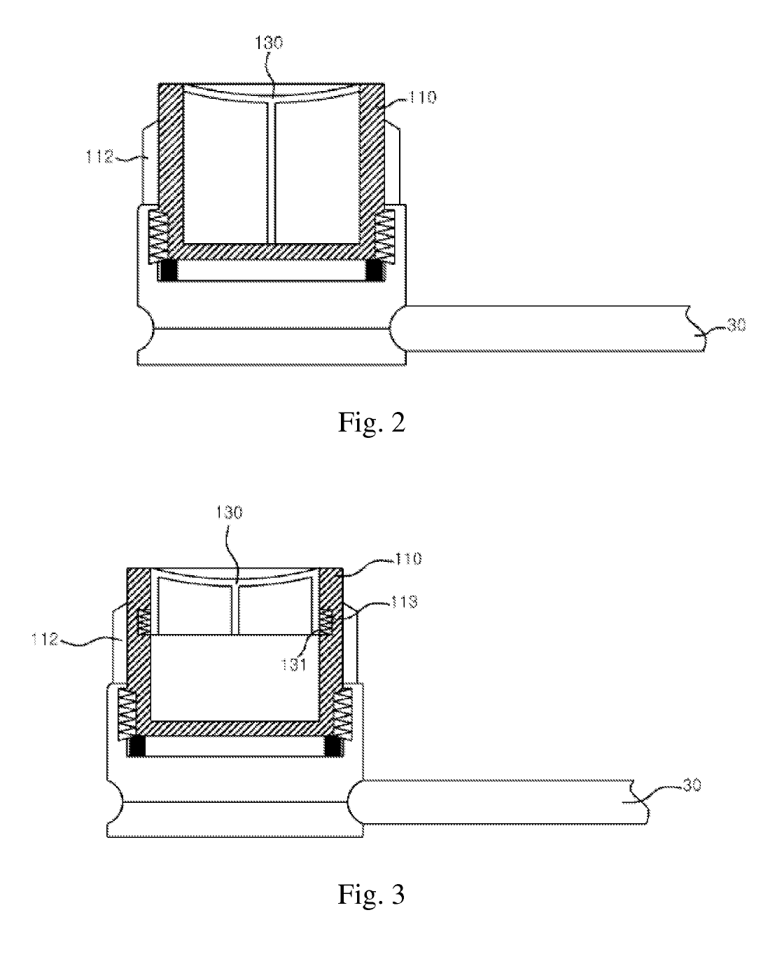

As illustrated in FIG. 3, the partition 130 may be insertable into or separable from the front portion of the main body 110. A screw 113 having a predetermined depth is disposed on an inner surface of the front portion of the main body 110, and a partition screw 131 is disposed on the lower circumferential portion of the partition 130. Thus, the main body 110 may be screw-coupled to the partition 130.

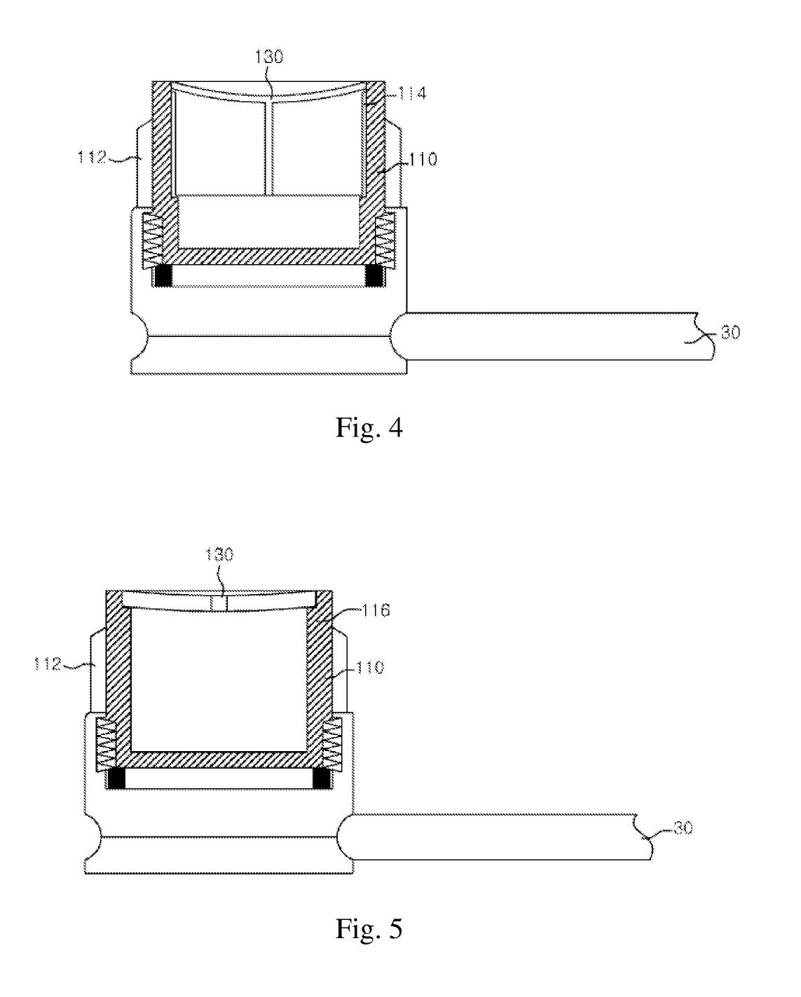

As illustrated in FIG. 4, the partition 130 is separated from the main body 110 to define a coupling groove 114 in the main body 110 so that the partition 130 is slidably inserted into or separated from the main body.

As illustrated in FIG. 5, the partition 130 may have a less width so that the partition 130 is inserted only up to a protrusion 116 disposed on the front portion of the main body 110.

According to another embodiment of the present invention, as illustrated in FIG. 8, a suction opening 100 includes a socket 150 that is coupled to a handle 30 and has a socket protrusion 152 therein and a coupling part 120 on a rear portion thereof. In addition, a partition body 140 including a partition 130 is inserted into and fixed to a front portion of the socket 150.

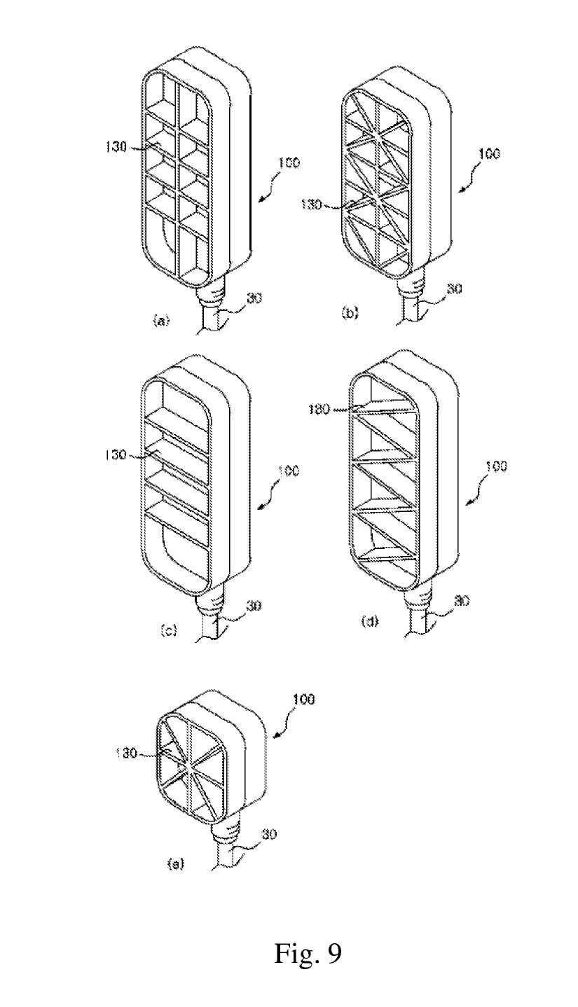

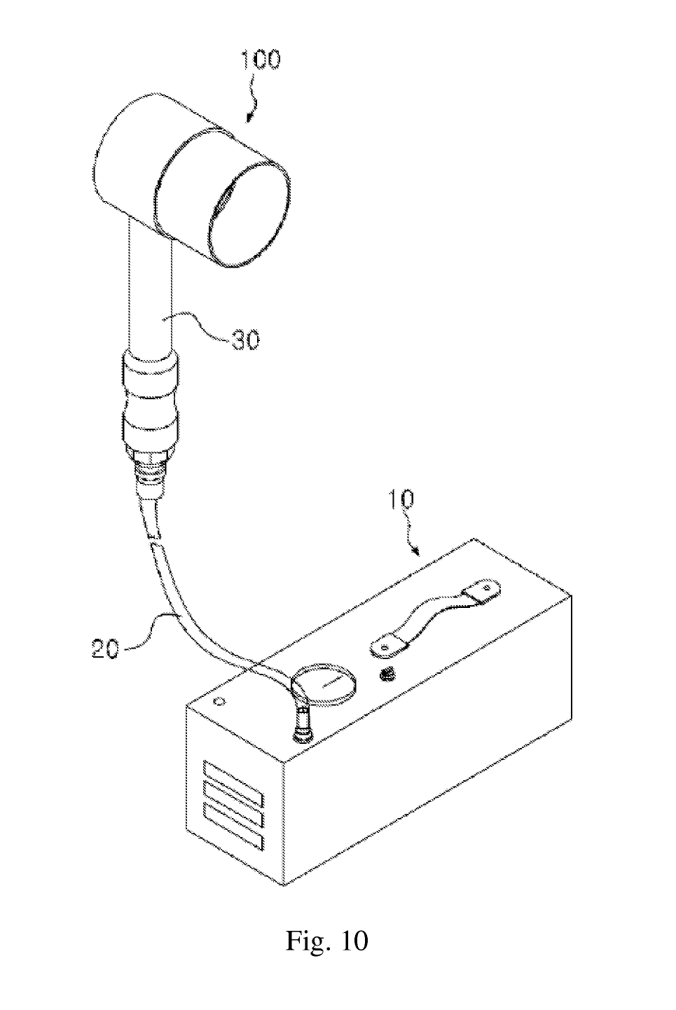

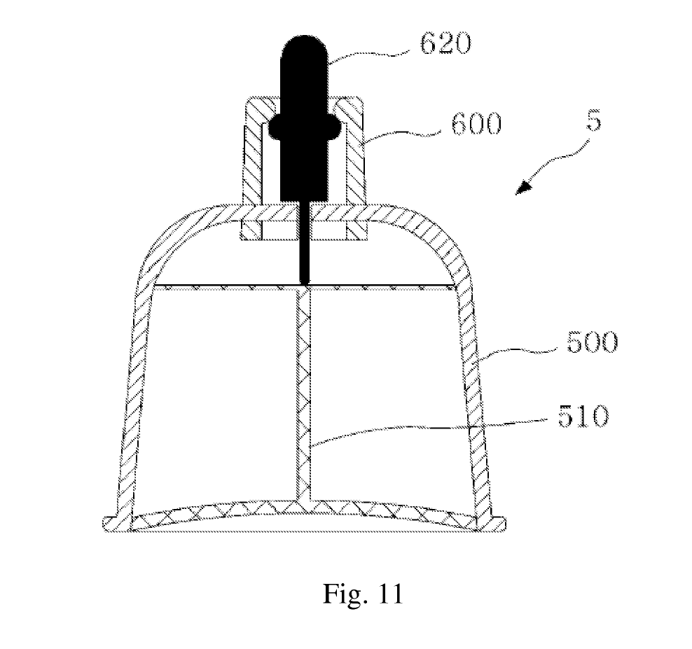

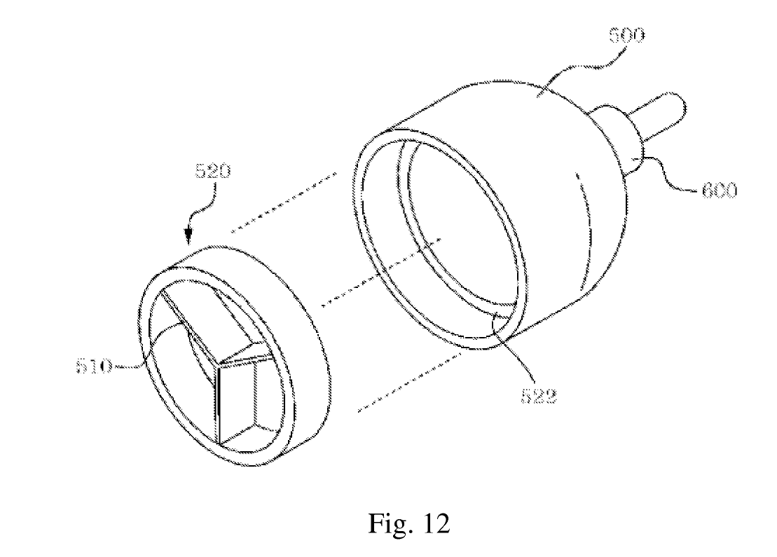

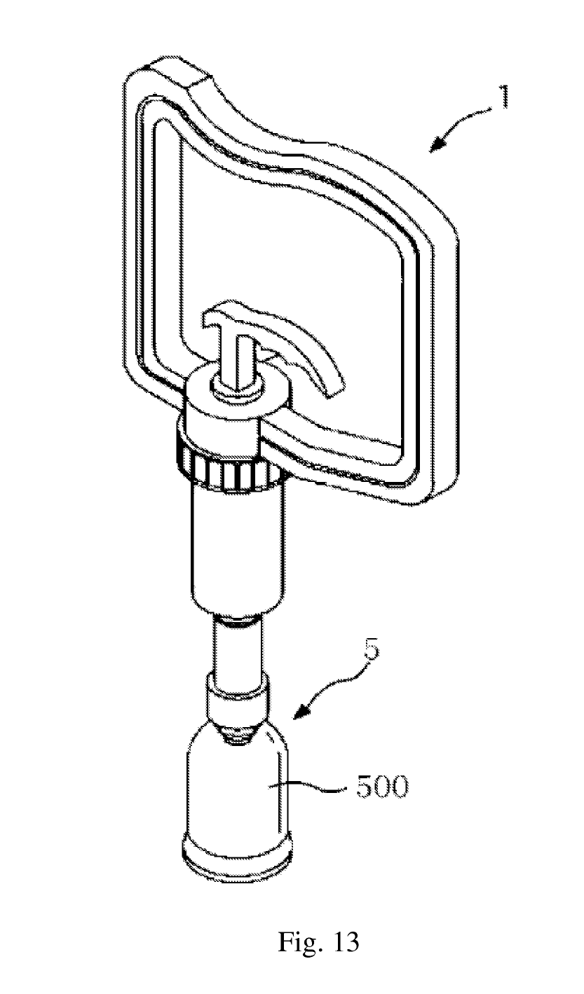

Also, as illustrated in FIG. 9, the suction opening 100 according to the present invention may have a rectangular or square shape in preparation for a case in which a therapy portion is long. Here, the partition 130 disposed within the suction opening 100 may have various shapes such as illustrated in FIGS. 9(a), (b), (c), (d), and (e).

Since the shape of the suction opening or the partition can be easily changed by a person skilled in the part, the present invention is not limited thereto, and thus the change in shape may be included in the scope of the present invention.

According to further another embodiment of the present invention, a cupping cup 5 may be a general cupping cup 5 including a container 500 and a protrusion 600.

A partition 510 is disposed within the container 500.

The container 500 may have an upside-down container shape. The protrusion 600 is disposed on an upper end of the container 500, and the partition 510 is disposed within the container 500.

The partition 510 is disposed within the container 500 and has various shapes such as a cross shape, a “Y” shape, a straight shape, a lattice shape, a cross shape having a circular center, and the like, as illustrated in FIG. 7.

That is, an inner space of the container 500 may be partitioned by the partition 510. For example, the inner space may be divided into four parts by the cross-shaped partition 510, divided into three parts by the Y-shaped partition 510, and divided into two parts by the straight-shaped partition 510.

The partition 510 may have a lower end that is disposed in parallel to a lower end of the container 500. The lower end of the partition 510 may be gradually concavely retreated toward a central portion thereof.

Also, according to further another embodiment of the present invention, in a cupping cup 5, a protrusion 522 protrudes from an inner wall of a container 500, and a partition body 520 having a ring shape with the same thickness as that of the protrusion 522 is provided. In addition, a partition 510 is disposed within the partition body 520.

Hereinafter, operations of the suction opening and cupping cup for the vacuum absorption type massage machine according to a preferred embodiment of the present invention will be described.

For utilizing the suction opening for the vacuum absorption type massage machine according to a preferred embodiment of the present invention, the suction opening 100 is coupled to a front portion of an upper end of the handle 30. Here, the suction opening 100 may be coupled by using the coupling part 120 disposed on the main body 110 of the suction opening 100.

The partition 130 is disposed within the main body 100. The partition 130 may have a shape that is gradually concave from a front end toward a central portion thereof.

When the suction opening 100 of the present invention is attached to the vacuum absorption type massage machine, and a vacuum pump of the main body 10 operates, a skin may be expanded toward the inside of the suction opening 100.

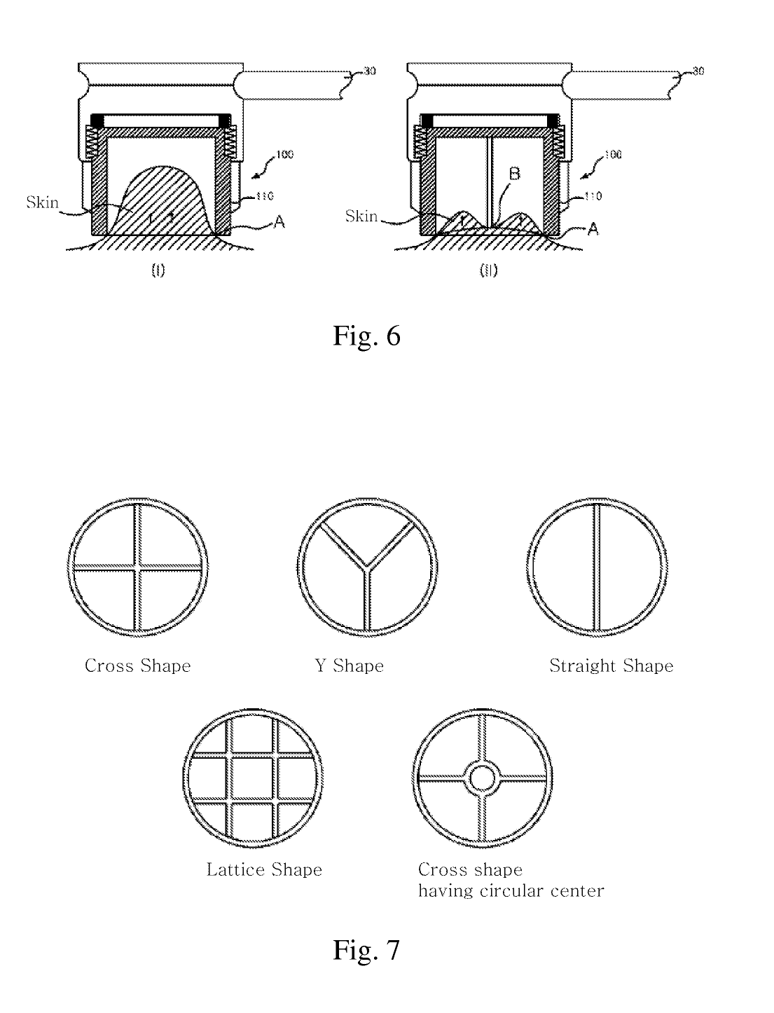

FIG. 6(I) illustrates an expanded degree of a skin when the massage therapy is performed by using the conventional suction opening 100, and FIG. 6(II) illustrates an expanded degree of a skin when the massage therapy is performed by suing the suction opening 100 of the present invention.

In the case where the conventional suction opening 100 is used, as illustrated in FIG. 6(I), since a portion A contacting a skin may be narrow, and the skin is seriously pulled up, a person that gets the massage therapy may feel severe pain. On the other hand, in the case where the suction opening 100 of the present invention is used as illustrated in FIG. 6(II), since a portion B except for a portion A presses a skin to prevent the skin from being seriously pulled up, a person that gets the massage therapy may not feel severe pain.

However, since the massage effects may depend on a locally applied vacuum pressure, but do not depend on an expanded degree of the skin, the person that gets the massage therapy may feel relatively less pain without being reduced in massage effects. Thus, a stronger vacuum pressure may be applied for massaging.

To confirm the massage effects of the present invention, for comparing a time that takes to remove a mark on a massaged portion in the case where the conventional suction opening 100 is used to a time that takes to remove a mark on a massaged portion in the case where the suction opening 100 of the present invention is used, the massage was performed on two portions of the abdomen of each of ten ordinary persons by using the suction opening 100 of the present invention and the conventional suction opening 100. Here, the number of days that takes until the marks are removed after air is suctioned under the same pressure was checked.

TABLE 1

| | Conventional | Suction opening of |
|---|---|---|
| | suction opening | the present invention |
| Average days | 9.2 days | 6.8 days |
| taking to remove mark | | |

As shown in Table 1, it is seen that days taking to remove the mark after being massaged using the suction opening 100 of the present invention are faster about 2 days than those taking to remove the mark after being massaged using the conventional suction opening 100.

Table 1 shows average days taking to remove marks after being massaged using the cupping cup 5 when the above-described method is equally performed according to another embodiment of the present invention.

TABLE 2

| | Conventional | Cupping cup of |
|---|---|---|
| | cupping cup | the present invention |
| Average days | 6.5 days | 4 days |
| taking to remove mark | | |

As shown in Table 2, it is seen that days taking to remove the mark after being massaged using the conventional cupping cup 5 are slower about 2.5 days than those taking to remove the mark after being massaged using the cupping cup 5 of the present invention.

According to the suction opening and cupping cup for the vacuum absorption type massage machine, since a portion pressing the skin is widely distributed by the partition when air is suctioned into the suction opening or the cupping cup by the vacuum pump or compressor, a person that gets the massage may feel relatively less pain. Also, since the mark generated on the skin is divided into several portions, and the applied pressure is dispersed, the mark on the skin may be quickly removed. Also, since the person that gets the massage feels relatively less pain even though the vacuum or compressor operates to apply a higher pressure so as to suction air into the suction opening or cupping cup, the massage effects may increase double.

While the present invention has been particularly shown and described with reference to the accompanying drawings according to exemplary embodiments, it will be understood by those of ordinary skill in the art that various changes in form and details may be made therein without departing from the spirit and scope of the present invention as defined by the following claims.

1. A suction opening for a vacuum absorption type massage machine, which is coupled to a handle of the vacuum absorption type massage machine, the suction opening comprising:
a main body;
a coupling part disposed at a rear portion of the main body, the coupling part being coupled to the handle, and
a partition disposed within the main body.

2. The suction opening of claim 1, further comprising a socket coupled to the handle, the socket comprising a socket protrusion therein and the coupling part disposed on a rear portion thereof, and
wherein a partition body comprising the partition is inserted and fixed to a front portion of the socket.

3. The suction opening of claim 1, wherein a fixing wing part protrudes from a circumferential portion of the main body.

4. The suction opening of claim 1, wherein a screw is disposed on an inner surface of a front portion, and
a partition screw is disposed on a circumferential portion of a lower end of the partition.

5. The suction opening of claim 1, wherein, when viewed from a front side, the partition (130) has one of a cross shape, a “Y” shape, a straight shape, a lattice shape, and a cross shape having a circular center.

6. A general cupping cup comprising a container and a protrusion, characterized in that a partition is disposed within the container.

7. A general cupping cup comprising a container and a protrusion, characterized in that a protrusion protrudes from an inner wall, a partition body having a ring shape with the same thickness as that of the protrusion is provided, and a partition is disposed within the partition body.

8. The suction opening of claim 3, wherein a screw is disposed on an inner surface of a front portion, and
a partition screw is disposed on a circumferential portion of a lower end of the partition.

9. The suction opening of claim 2, wherein, when viewed from a front side, the partition (130) has one of a cross shape, a “Y” shape, a straight shape, a lattice shape, and a cross shape having a circular center.
